(19) United States
(12) Patent Application Publication
(10) Pub. No.: US 2002/0184045 A1
(43) Pub. Date: Dec. 5, 2002

(54) System and method of managing and administering benefit plans

(75) Inventor: Scott VanDeursen, San Anselmo, CA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Trust Benefits Online LLC

(21) Appl. No.: 09/985,648

(22) Filed: Nov. 5, 2001

Related U.S. Application Data
(60) Provisional application No. 60/286,370, filed on Apr. 26, 2001.

(51) Int. Cl. G06F 17/60

(52) U.S. Cl. 705/1

(57) ABSTRACT

The method and system of the present invention provides web access and fund administration for both the client administrator of benefit plans and for the participants in the plans. The method and system of the present invention provides a one-stop, total solution approach. The method and system of the present invention includes design, hosting, data management, and site update feature. A host server is provided having a memory. A database is created by inputting employee information. The database is stored in the host server memory. The employee plan eligibility and benefits data is calculated using the inputted employee information. The calculated employee plan eligibility and benefits data for each employee is stored in a personalized employee account. The personalized employee accounts are stored in the host server memory. The database is accessed by an employer to update the information stored in the database as required. The employee accounts are accessed by the employee to view the calculated employee plan eligibility and benefits data.

### CROSS REFERENCE TO RELATED APPLICATION

This application claims the benefit under 35 U.S.C. § 119(e) of provisional patent application Serial No. 60/286,370, filed Apr. 26, 2001.

### FIELD OF THE INVENTION

The present invention relates to a method and system of managing and administering benefit plans. More particularly, the present invention relates to a method and system of providing interactive information exchange capabilities to employee benefit plans via contemporary web and Internet technologies. Through the utilization of web technologies, the present invention connects the administrator, participants, employers and vendors, thereby allowing all aspects of benefit plans to be accomplished over the Internet.

### BACKGROUND OF THE INVENTION

Presently there is no provider of a fully integrated solution that handles all benefit plan administration activities and information exchange via the Internet. Some providers offer web site access for a benefit plan participant, while others provide benefit plan management services. Therefore, a need exists for a method and system providing a one-stop, total solution approach to accessing and administering benefit plans. The method and system of the present invention provides both business-to-employee and business-to-business benefit plan administration and information exchange over the Internet.

### SUMMARY OF THE INVENTION

The method and system of the present invention provides web access and fund administration for both the client administrator of benefit plans and for the participants in the plans. The method and system of the present invention provides a one-stop, total solution approach. The method and system of the present invention includes design, hosting, data management, and site update feature.

The present invention provides a method of administering benefit plans. A host server is provided having a memory. A database is created by inputting employee information. The database is stored in the host server memory. The employee plan eligibility and benefits data is calculated using the inputted employee information. The calculated employee plan eligibility and benefits data for each employee is stored in a personalized employee account. The personalized employee accounts are stored in the host server memory. The database is accessed by an employer to update the information stored in the database as required. The employee accounts are accessed by the employee to view the calculated employee plan eligibility and benefits data.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

Referring now to the drawings that form a part of the original disclosure:

FIG. 1 is a flowchart of a system architecture diagram of the environment of the method and system of the present invention.

### DETAILED DESCRIPTION OF THE INVENTION

The method and system of the present invention comprises two basic modules. The first module is a web based participant access tool. The second module is a back end fund administration system. These two modules integrate seamlessly to allow participants to access pertinent information in a secure manner via the web (referred to as a business-to-employee module) and to distribute funds to administer benefits (referred to as a business-to-business module).

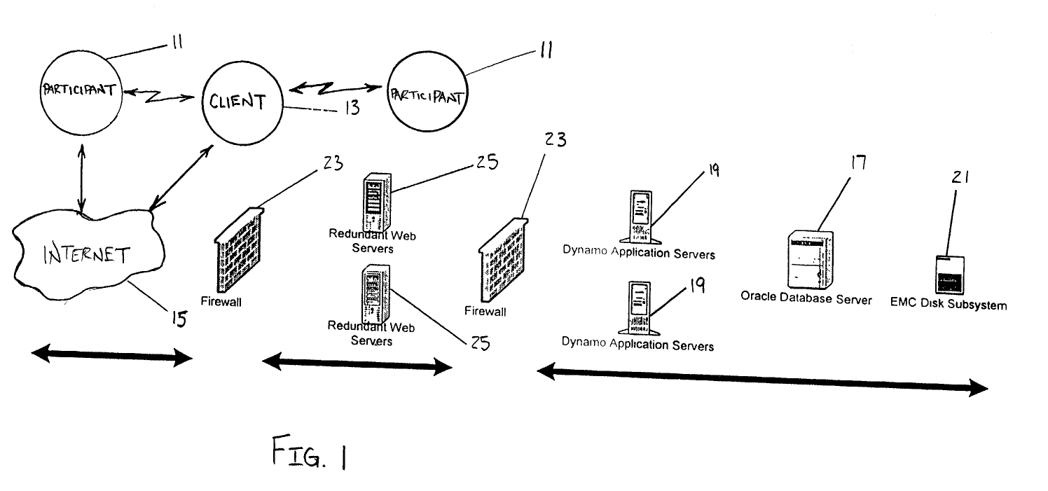

The web based participant access tool module provides a web interface for funds that contain various summary plan descriptions, frequently asked questions, news and update information, and other relevant plan information. The business-to-employee module includes deploying benefit information via the Internet 15 to the participants 11 associated with the clients 13, as shown in FIG. 1. The product module may include a home page that displays the client's particular fund information and access to specific benefit “sub-modules”. The information on the site may be completely secured (whereby only participants with authorized access may get to any information on the site), partially secured (so that the general public may access only certain portions of the site), or unsecured. Those clients who prefer to have their entire site protected against public access may have their participants access their benefit information in a secured manner in two ways, both of which are shown in FIG. 1: (1) via the server's gateway or (2) via the client's individual URL.

The site delivers benefit information in an easy to use format and includes all relevant information about the plan or plans, such as the summary plan description, Board of Trustees background, frequently asked questions, contact information, and sections related to the effect of life events and changes in employment on benefits. The site may also provide for secured access, via a user-defined username and personal identification number (PIN), for participants 11 to view their particular demographic information, employer reported work history, pension balances, estimates of future pension benefits, health & welfare enrollment and eligibility information, as well as vacation and defined contribution balances. E-mail communication capabilities for the fund may also be provided.

The sites are deployed via standard templates and allow for customization by inclusion of graphics, images, streaming video, or other media specific to the clients' industries.

The back end fund administration module administers all types of benefits. See Table I for a description of some typical benefits that may be administered. The business-to-business module may be customized to accommodate all the specific requirements for a single employer, multi-employer, or public sector benefit groups. The module integrates seamlessly with the business-to-employee module used for the delivery of benefits information to participants 11 via the Internet 15.

TABLE I
Description of Typical Funds

| Type of Fund | Description |
|---|---|
| Defined Benefit | Provides demographic, beneficiary, work |
| | history and benefit calculation information |
| Defined Contribution | Provides demographic, beneficiary, contribution |
| | history and account balance information |
| Health | Provides demographic, dependent, work history, |
| | enrollment and eligibility information |
| Vacation | Provides demographic, contributions and account |
| | balance information |
| Other | Static information on ancillary funds, such as |
| | scholarship, apprenticeship, etc. |

The server provides all hosting and data management services associated with the above modules. Also, site update services may be provided by the server

The modules may be available as either a web-enabled, “turn-key” application (a bundled application package run on the client's own site server), or as an application solution provider (ASP) interface that allows clients the ability to connect to a third party server and utilize their data processing services. Some of the sub-modules that may be included in the suite of employee benefit administration applications include, but are not limited to:

Defined Benefit Pension Module

Health and Welfare Module

Legal Claims Processing Module

Cost Accounting Module

Participant Module

Security System Module

Client and Trust Module

Address Maintenance Module

Human Resources Module

Participant Self-Pay Accounting Module

Defined Contribution/Individual Account Plan Administration Module

Vacation Fund Administration Module

Reciprocity Processing Module

Employer Contribution Accounting Module

Benefit Payment Module

Contracts and Rates

In order to ensure the reliable and secure operation of the method and system of the present invention, a robust technology architecture was designed and implemented as shown in the system architecture diagram of FIG. 1. Sun Microsystems was selected as the vendor to supply servers 25 for the web, application, and database environments. Oracle's “Internet ready” relational database environment 17 was chosen because of its ability to scale and deliver data in a secure and reliable manner. Art Technology Group's “Dynamo” application server 19 was selected in order to provide a pure Java application interface, and facilitate the development of a “user customized” portal environment. An EMC disk subsystem 21 was acquired in order to ensure high availability and protection of data. Verisign security authentication software was acquired in order to secure private information with the industry's most widely used Internet security product. The network infrastructure consists of Cisco routers and firewall 23 and Bay Networks hubs and switches.

The method and system of the present invention serves all types and sizes of benefit plans, including for example, multi-employer, single-employer and public clients. The method and system may serve retirement (both defined benefit and defined contribution), health and welfare, apprenticeship and vacation plans, and may be scaled to accommodate almost any other type of benefit.

The method and system of the present invention not only provides and maintains participant benefits on the Internet, but also provides the mechanisms required to allow participants to access the Internet and obtain benefit information. A client may be provided with a kiosk at an appropriate site, such as local union offices or employer lunch rooms, that allows participants to obtain benefit information.

The method and system of the present invention are designed for and are capable of handling any type of benefit for any type of plan. Presently, there are several thousand employee benefit plans that provide various benefits to millions of workers. These plans may be segregated into four primary “types”: Taft/Hartley Multi-Employer, Taft/Hartley Single Employer, Public Sector, and Corporate.

The Taft/Hartley Multi-Employer plans provide benefits to union members that work for one of a number of employers that have a contract with a local or locals.

The Taft/Hartley Single Employer plans provide benefits to union members that work for one specific employer. For purposes of this document, all Taft/Hartley plans generally will be considered as the same “type”.

The Public Sector plans provide benefits to municipal and government employees, who are often part of a union.

The Corporate plans provide benefits to employees of a specific company; these plans have no union associated with the employees.

While advantageous embodiments have been chosen to illustrate the invention, it will be understood by those skilled in the art that various changes and modifications may be made therein without departing from the scope of the invention as defined in the appended claims.

What is claimed is:

1. A method of administering benefit plans, comprising:
providing a host server having a memory;
creating a database by inputting employee information;
storing the database in the host server memory;
calculating employee plan eligibility and benefits data using the inputted employee information;
storing the calculated employee plan eligibility and benefits data for each employee in a personalized employee account;
storing the personalized employee accounts in the host server memory;
accessing the database by an employer to update the information stored in the database as required; and
accessing the employee accounts by the employee to view the calculated employee plan eligibility and benefits data.

2. A method of administering benefit plans according to claim 1, further comprising
providing each employee with a personalized access code for accessing the database to obtain the employee's plan eligibility and benefits data.

3. A method of administering benefit plans according to claim 1, wherein
providing the host server comprises providing the host server that is accessible through an Internet web site.

4. A method of administering benefit plans according to claim 1, wherein
providing the host server comprises providing the host server that is accessible through a server's gateway.

5. A method of administering benefit plans according to claim 1, further comprising
redefining a variable used to calculate the employee plan eligibility and benefits data;
recalculating the employee plan eligibility and benefits data using the redefined variable;
storing the recalculated employee plan eligibility and benefits for each employee in a personalized employee account; and
accessing the employee accounts by the employee to view the recalculated employee plan eligibility and benefits data.

6. A method of administering benefit plans according to claim 5, wherein
redefining a variable used to calculate the employee plan eligibility and benefits data is redefined by the employee.

7. A method of administering benefit plans according to claim 5, wherein
redefining a variable used to calculate the employee plan eligibility and benefits data is redefined by the employer.

8. A method of administering benefit plans, comprising:
connecting at least one client personal computer (PC) to a host server, the server having a memory;
creating a database by inputting employee information;
storing the database in the memory of the host server;
calculating employee plan eligibility and benefits data for each employee using the inputted employee information;
storing the calculated employee plan eligibility and benefits data for each employee in a personalized employee account;
storing the personalized employee accounts in the host server memory;
accessing the server from the at least one client PC;
entering a personalized access code by an employee at the at least one client PC, the code corresponding to the employee's personalized employee account;
sending the data stored in the personalized employee account corresponding to the entered code to the accessing client PC;
redefining a variable used to calculate the employee's plan eligibility and benefits data at the accessing client PC;
recalculating the employee's plan eligibility and benefits data with the redefined variable;
viewing the recalculated employee's plan eligibility and benefits plan data from the accessing client PC.

9. A method of administering benefit plans according to claim 7, wherein
connecting said at least one client PC to the host server comprises connecting said at least one client PC to the host server with a LAN network.

10. A method of administering benefit plans according to claim 7, wherein
connecting said at least one client PC to the host server comprises connecting said at least one client PC to the host server with a WAN network.

11. A method of administering benefit plans according to claim 7, further comprising
accessing the host server from the at least one client PC through an Internet web site.

12. A method of administering benefit plans according to claim 7, further comprising
accessing the host server from the at least one client PC through a server's gateway.

13. A method of administering benefit plans according to claim 7, further comprising
entering an access code by the employer at the at least one client PC, the code corresponding to all the employee's personalized employee accounts; and
sending the data stored in all the personalized employee accounts to the accessing client PC.

14. A method of administering benefit plans according to claim 13, further comprising
updating employee information; and
storing the updated information in the database.
